(19) United States
(12) Patent Application Publication
(10) Pub. No.: US 2024/0405398 A1
(43) Pub. Date: Dec. 5, 2024

(54) METHOD FOR INSULATING A BATTERY CELL

(71) Applicant: Volkswagen Aktiengesellschaft, Wolfsburg (DE)

(72) Inventor: Lukas KWOCZEK, Braunschweig (DE)

(73) Assignee: Volkswagen Aktiengesellschaft, Wolfsburg (DE)

(21) Appl. No.: 18/680,807

(22) Filed: May 31, 2024

(30) Foreign Application Priority Data
May 31, 2023 (DE) 10 2023 205 063.3

(51) Int. Cl. H01M 50/595; H01M 50/103; H01M 50/588

(52) U.S. Cl. CPC H01M 50/595; H01M 50/103; H01M 50/588

(57) ABSTRACT

A method for insulating a battery cell is provided. The battery cell has a battery housing with an electrical contact element for electrically contacting a pole of the battery cell. A portion of the battery housing of the battery cell is provided with an insulating layer, and a section of an insulation material is adhesively bonded to a region of the battery housing situated between the electrical contact element and the insulating layer, and this region of the battery housing is thus electrically insulated. The insulation material is provided as a rolled-up strip, and the section is rolled off from the rolled-up strip and separated before the section is adhesively bonded to the battery housing.

This nonprovisional application claims priority under 35 U.S.C. § 119(a) to German Patent Application No. 10 2023 205 063.3, which was filed in Germany on May 31, 2023, and which is herein incorporated by reference.

### BACKGROUND OF THE INVENTION

### Field of the Invention

The invention relates to a method for insulating a battery cell.

### Description of the Background Art

Battery cells of this type have a battery housing with at least one electrical contact element for electrically contacting a pole of the battery cell.

To electrically insulate the battery housing, a portion of the battery housing of the battery cell is routinely provided with an insulating layer. This may take place on a large portion of the surface of the battery housing without particular technical challenges arising. In practice, however, the battery housings have special features at some locations which impede or prevent the application of an insulating layer.

For this reason, in the prior art methods have been developed which provide additional insulation measures for the insulating layer in order to enable sufficient electrical insulation of the battery housing.

Thus, for example, DE 10 2011 077 292 A1 and DE 10 2017 216 673 A1 disclose methods in which weld seams of such battery housings are insulated separately by covering them with strips made of an insulation material.

Another difficulty with the electrical insulation of such battery housings is the electrical insulation of regions of the battery housing situated between the electrical contact element of the battery housing and the insulating layer. In practice, it is often not possible, or at least not possible with reasonable effort, for the insulating layer, which is applied to a portion of the battery housing of the battery cell, to reach closely enough to the electrical contact element that a region of the battery housing between the contact element and the insulating layer does not have to be electrically insulated by means of further insulation measures.

In practice, according to the prior art the electrical insulation of such regions is achieved in particular by adhesively bonding sections of an insulation material to these regions, and thus electrically insulating them. According to the prior art, the sections are punched out and applied to a substrate which is rolled up and provided in the rolled-up state. During manufacture of the battery cell, the substrate material is unrolled, and the sections are removed from the substrate material and adhesively bonded to the appropriate regions of the battery cells. This often involves regions of the battery cells that enclose the electrical contact elements. The sections often have recesses in order to apply effective electrical insulation to such regions. The sections are then adhesively bonded in such a way that the contact elements pass through the recesses, and the section thus encloses the contact element.

However, a drawback of such methods is that the costs for electrical insulation are comparatively high. This is due to the fact that the sections must be provided so that they are adapted to the regions to be insulated, to which they are to be adhesively bonded. Correspondingly, individually prefabricated sections are produced on substrate materials, resulting in high material costs for the sections. In addition, handling of the prefabricated sections is often difficult due to their shape, in which the recess, at least in areas, is frequently enclosed by very narrow strips of the insulation material.

### SUMMARY OF THE INVENTION

It is therefore an object of the present invention to provide a method for insulating a battery cell, which has lower material costs and is easy to carry out.

The battery cells, according to an example of the invention, to be insulated have a battery housing with an electrical contact element for electrically contacting a pole of the battery cell. The battery cell in particular is a secondary battery and/or a rechargeable battery, for example a lithium-ion rechargeable battery.

A portion of the battery housing of the battery cell is provided with an insulating layer. This may take place in particular after the battery housing has been closed. The battery housing may in particular be a battery housing made of a metallic material.

The battery may be a prismatic cell. Prismatic cells have a battery housing having an at least essentially cuboidal basic shape. Corresponding faces of the battery housing are defined by this basic shape. In this regard, the insulating layer may be applied in particular to a portion of the battery housing having four faces that are defined by the basic shape and that adjoin one another in such a way that they form a circumferential surface of the battery housing based on its basic shape, and at which in particular no contact element is situated.

The insulating layer may in particular be formed by an in particular band-shaped material that is applied to the battery cell. Specifically, in particular band-shaped material may be wound around the battery cell in order to provide the battery cell with the insulating layer. The material may in particular be a film. It has been shown that battery cells insulated in this way are particularly well suited for the described method.

A section of an insulation material is adhesively bonded to a region of the battery housing situated between the electrical contact element and the insulating layer, and thus electrically insulates this region. The region may enclose the electrical contact element. In particular for battery cells in which the insulating layer is applied in the above-described manner, it is often necessary to electrically insulate such a region using an insulation measure that supplements the insulating layer, since it is often not possible, or at least not possible with reasonable effort, to design the insulating layer so that it reaches closely enough to the contact element.

The object is achieved in particular in that the insulation material is provided as a rolled-up strip, and the section is unrolled from the rolled-up strip and separated before the section is adhesively bonded to the battery housing. The insulation material may in particular be polyethylene terephthalate (PET).

It has been found that the insulation task may also be achieved by unrolling the sections from a rolled-up strip of the insulation material and separating them before they are adhesively bonded to the region of the battery housing to be insulated. However, rolled-up strips of the insulation material may be provided in a much more cost-effective manner than the completely fabricated sections that are provided on a substrate material. The material costs for the method for insulating the battery housing may be significantly reduced in this way.

The method may provide that the strip is provided with a self-adhesive coating before it is rolled up. Such a strip facilitates carrying out the method with regard to establishing the adhesive bond for the section, since this may take place in a simple manner by means of the self-adhesive coating.

The method may provide that recesses are introduced into the strip before the strip is rolled up. In this way, a starting material may be produced that is adapted to the insulation task to be achieved, in which, however, the main reason for the significant advantage with regard to material costs and handling, namely, the provision of the strip as continuous rolled-up strips, is not lost, and furthermore results in reduced costs. The recesses may, for example, be introduced into the strip by punching out pieces of the strip from the strip. The recesses may be provided in a cost-effective manner via such punching out.

The strips with the introduced recesses allow the section to be adhesively bonded to the region of the battery housing in such a way that the contact element passes through a recess in the section, and the section encloses the contact element. A region of the battery housing that encloses the contact element and that is situated between the contact element and the insulating layer may thus be electrically insulated using a single section. The recesses are in particular adapted to the contact element and distributed over the length of the strip in such a way that each section has a recess after the sections are separated from the strip.

The method may also provide that a plurality of sections are adhesively bonded to the region of the battery housing, overlapping one another in such a way that the sections are combined to form a continuous section assembly. In this way, even complex geometries of the regions to be insulated by means of the sections may be insulated, in that their shape is duplicated by the section assembly made up of the sections. It has been shown that such “patchwork-like” insulation is well suited for reliably electrically insulating such regions of a battery housing of a battery cell. At the same time, the sections may be separated from rolled-up strips, and thus from an economical starting material, which ideally is already commercially available.

The method may provide that the sections are made up in such a way that the section assembly has a recess that is enclosed by the sections, and the contact element passes through this recess, so that the section assembly encloses the contact element. In this way, insulation that encloses the contact element may also be provided by means of the section assembly.

The method may provide that a plurality of rolled-up strips having different widths are provided, and sections are unrolled from the plurality of rolled-up strips and separated, and the section assembly is made up of sections having different widths. By such use of strips having different widths, the possible geometry of the section assembly may be varied more easily, and in more ways, than when just one strip having one width is used as a source for the sections. In particular, two rolled-up strips having different widths may be provided, and sections of both rolled-up strips may be unrolled and separated. In this case, the section assembly may in each case be made up in particular of two sections of both strips. The section assembly may be made up in such a way that the sections of the same strip are situated opposite one another relative to the contact element. With such a section assembly, in particular the regions to be insulated, typically in the case of prismatic cells, may be insulated particularly well around the contact elements of the particular cell. Such a section assembly may be adapted particularly well, with respect to its geometry, to these regions.

The method may also provide that sections and/or section assemblies are adhesively bonded to a plurality of regions of the battery housing situated between the contact element and the insulating layer in such a way that a plurality of separate sections and/or section assemblies results. Such an arrangement of the sections and/or section assemblies may be meaningful in particular when the insulating layer at segments of the circumference of the contact element reaches closely enough to the contact element that additional insulation of the battery housing between the contact element and the insulating layer may be dispensed with at these segments. It is then sufficient to adhesively bond the sections and/or section assemblies only to those regions between the contact element and the insulating layer that are situated at the segments of the circumference of the contact element at which the insulating layer does not adequately reach the contact element.

The contact element may be situated at a face that is defined by the basic shape of the battery.

The method may also provide that the contact element can be situated at a face that is defined by the basic shape of the battery cell. Alternatively and/or additionally, a plurality of, in particular two, contact elements may be situated at a face that is defined by the basic shape of the battery cell. It is particularly advantageous when the edge region of the insulating layer, which during provision of the battery cell with the insulating layer is applied to faces adjoining the face with the contact element or the plurality of contact elements, via edges, is applied to this face, extending over the edges along the surface of the battery housing and into the face with the contact element or the plurality of contact elements. For this purpose, in particular a film that is formed from the insulating layer may be bent and/or folded around the edges.

The section and/or the section assembly may be adhesively bonded overlapping with an edge region of the insulating layer. The edge region may in particular be an edge region that extends over edges along the surface of the battery housing into the face with the contact element or the plurality of contact elements. Due to the overlap between the insulating layer and the section and/or section assembly, secure electrical insulation may be ensured, even in the region of the transition between the section and/or section assembly on the one hand and the insulating layer on the other hand.

The battery cells may have an at least essentially cuboidal basic shape. At opposite faces that are defined by the basic shape of the battery cells, the battery cells may in each case have a contact element and a region situated between the contact element and the insulating layer, or a plurality of regions of the battery housing situated between the contact element and the insulating layer, to which a section and/or a section assembly are/is adhesively bonded. In such battery cells, the savings made possible by the above-described method are particularly high, since electrical insulation via adhesively bonded sections takes place at two opposite sides of the battery cell, and therefore two of the costly sections, which according to the prior art are individually provided accommodated on a substrate material, may be replaced.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic illustration of a method according to the prior art,

FIG. 2 shows a schematic illustration of an example of a method for insulating battery cells according to an example,

FIG. 3 shows a schematic illustration of an example of a method for insulating battery cells according to an example, and

FIG. 4 shows a schematic illustration of an example of a method for insulating battery cells according to an example.

### DETAILED DESCRIPTION

The figures each show a top view of a face of a battery cell 10 in the adhesively unbonded state (A), the section or the sections to which the battery cell is adhesively bonded (B), and a top view of the face in the adhesively bonded state (C).

The face illustrated in each of the figures, which is defined by the basic shape of the battery cell 10, has a contact element 12 that is centrally situated by way of example in the example shown. The battery cell 10 is provided with an insulating layer 14. In the examples shown, the insulating layer 14 is applied in particular to a portion of the battery housing that includes four faces that are defined by the basic shape, and that adjoin one another in such a way that they form a circumferential surface of the battery housing based on its basic shape, and at which no contact element is situated. When the battery cell 10 is provided with the insulating layer 14, an edge region of this insulating layer 14 is applied to the illustrated face at which the contact element 12 is situated. This edge region extends via edges along the surface of the battery housing into the illustrated face with the contact element 12. However, the insulating layer 14 does not reach closely enough to the contact element 12 for sufficient insulation to result in the region of the contact element 12. Rather, a region 16 of the battery housing between the electrical contact element 12 and the insulating layer 14 remains uninsulated.

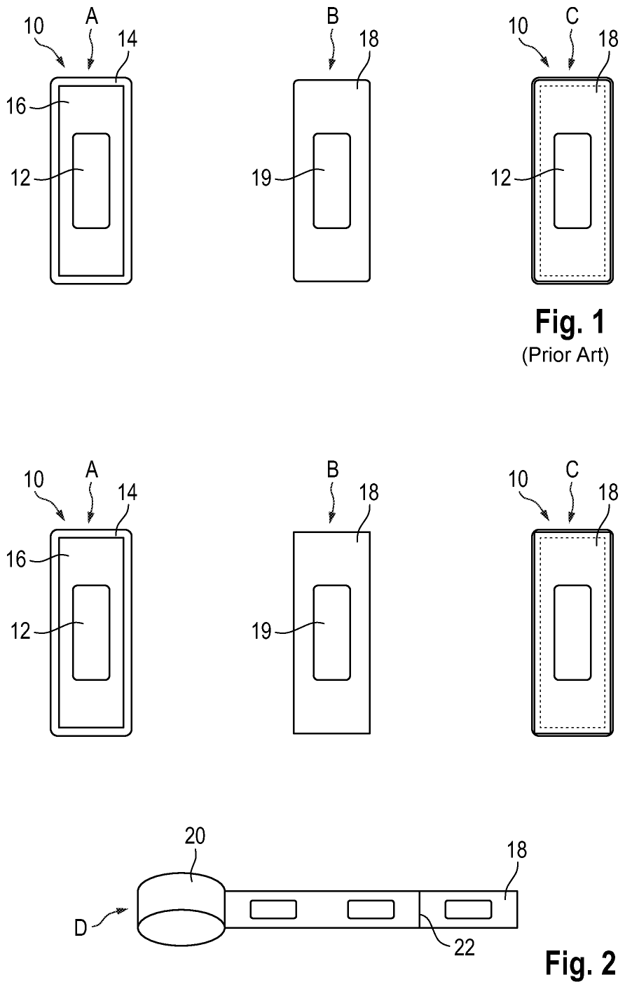

FIG. 1 shows the method according to the prior art. This state of the battery cell 10 is illustrated in FIG. 1A by way of example.

The methods according to the prior art provide that a section 18 of an insulation material is provided and adhesively bonded to the region 16 of the battery housing. The section 18 may be adhesively bonded to the battery cell 10 in such a way that the section overlaps with the edge region of the insulating layer 14. The resulting battery cell 10 with the adhesively bonded section 18 is illustrated in FIG. 1C.

The sections 18 used according to the prior art have recesses 19. When a section 18 is adhesively bonded to the battery cell 10, the contact element 12 is passed through the recess 19 in the section 18. In the case of the example from the prior art illustrated in FIG. 1, the section 18 thus encloses the contact elements 12.

According to an example illustrated in FIG. 2, the described method for insulating the battery cell 10 provides that the insulation material is provided as a rolled-up strip 20. The sections 18 illustrated in FIG. 2B by way of example are unrolled from the strip 20 and separated before the sections 18 are adhesively bonded to the battery cell 10 illustrated in FIG. 2A as an example, in order to obtain the battery cell 10 illustrated in FIG. 2C as a result.

Also in the case of the example illustrated in FIG. 2 as an example, the section 18 encloses the contact element 12, which is passed through a recess 19 in the section 18, when the section 18 is adhesively bonded to the battery cell 10. Accordingly, the strip 20 illustrated in FIG. 2D as an example already has recesses 19. When the sections 18 are separated from the strip 20, the separating points 22 as in the shown example may be selected in such a way that each section 18 has exactly one recess 19 for a contact element 12.

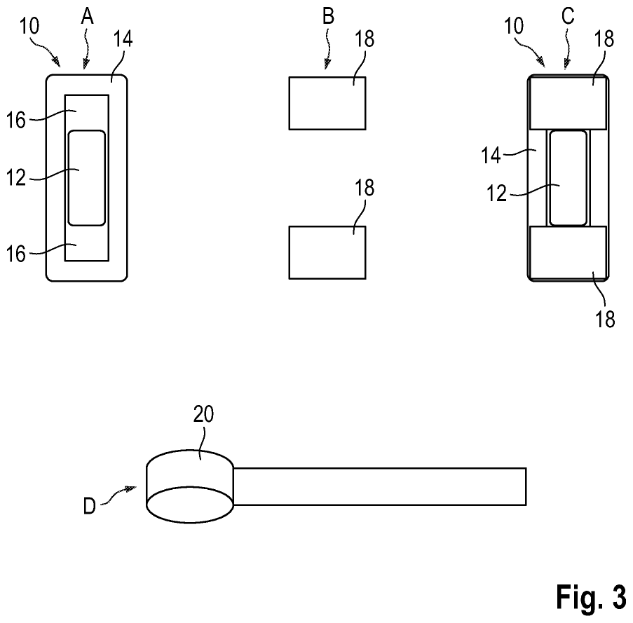

In the case of the example illustrated in FIG. 3, the edge region of the insulating layer 14 at segments of the circumference of the contact element 12 does not reach closely enough to the contact element 12 to allow additional insulation of the battery housing between the contact element 12 and the insulating layer 14 to be dispensed with at these segments of the circumference of the contact element 12, as is apparent from FIG. 3A. As a result, at the face illustrated by way of example, the battery cell 10 illustrated in FIG. 3A as an example has two regions 16 of the battery housing that are situated between the insulating layer 14 and the contact element 12 at segments of the circumference of the contact element 12 at which the insulating layer 14 does not sufficiently reach the contact element 12. In this case, the method may provide that each of these regions 16 of the battery housing is in each case adhesively bonded to a section 18, as illustrated in FIG. 3B as an example. Similarly, the sections 18, as illustrated in FIG. 3C as an example, are adhesively bonded to the battery cell 10 in such a way that two separate sections 18 result. Also, in this shown example, the sections 18 that are adhesively bonded to the battery cell 10 may overlap with the edge region of the insulating layer 14.

The strip 20 illustrated by way of example in FIG. 3D is likewise provided in a rolled-up form, and represents a very economical variant for a starting material for the sections 18.

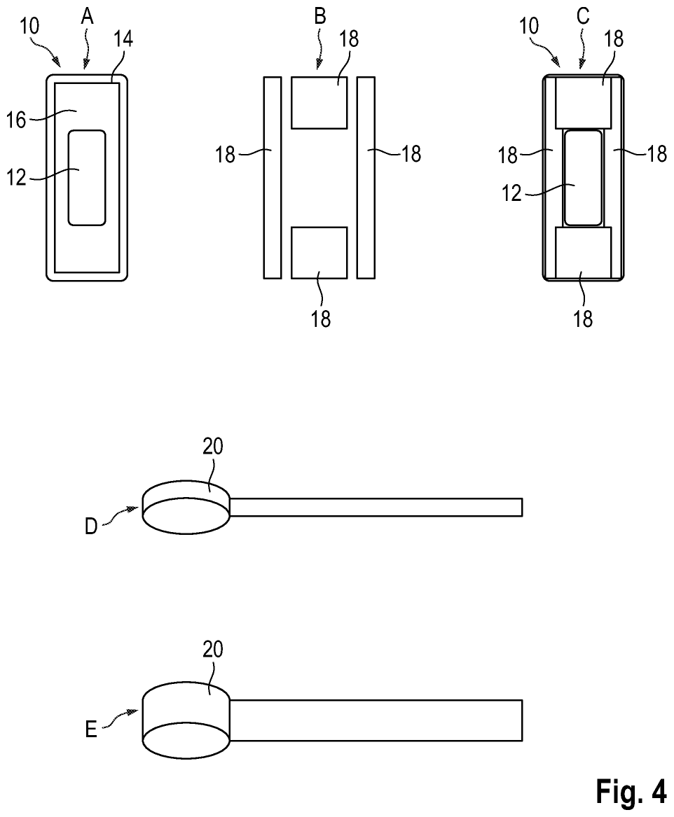

In the case of the example illustrated in FIG. 4, the design of the battery cell 10 as illustrated in FIG. 4A corresponds to the battery cells 10 illustrated by way of example in FIGS. 1 and 2. In order to insulate the region 16 of this battery cell 10 that encloses the contact element 12, in the case of the example illustrated in FIG. 4 a section assembly is formed from the four sections 18 illustrated by way of example in FIG. 4B. When the battery cell 10 is adhesively bonded, the sections 18 illustrated in FIG. 4B are combined to form the section assembly that is visible in FIG. 4C.

FIGS. 4D and 4E by way of example illustrate in each case strips 20 made of insulation material, from which the sections 18 illustrated in FIG. 4B are provided by separating them from the strips 20. As in the shown example, strips 20 having different widths may be utilized to obtain sections 18 having different geometries, which may then be advantageously combined to form a section assembly that is geometrically adapted to the region 16 of the battery housing to be insulated.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for insulating a battery cell, the method comprising:
providing the battery cell with a battery housing with an electrical contact element to electrically contact a pole of the battery cell;
providing a portion of the battery housing of the battery cell with an insulating layer;
adhesively bonding a section of an insulation material to a region of the battery housing arranged between the electrical contact element and the insulating layer, the region of the battery housing being thus electrically insulated; and
providing the insulation material as a rolled-up strip, the section being rolled off from the rolled-up strip and separated before the section is adhesively bonded to the battery housing.

2. The method according to claim 1, wherein the strip is provided with a self-adhesive coating before it is rolled up.

3. The method according to claim 1, wherein before the strip is rolled up, and recesses are introduced into the strip by punching out pieces of the strip from the strip.

4. The method according to claim 1, wherein the section is adhesively bonded to the region of the battery housing in such a way that the contact element passes through a recess in the section, and wherein the section encloses the contact element.

5. The method according to claim 1, wherein a plurality of sections are adhesively bonded to the region of the battery housing, overlapping one another such that the sections are combined to form a continuous section assembly.

6. The method according to claim 5, wherein the sections are made up such that the section assembly has a recess that is enclosed by sections, and the contact element passes through this recess so that the section assembly encloses the contact element.

7. The method according to claim 5, wherein a plurality of or two rolled-up strips having different widths are provided, sections of the plurality of rolled-up strips are unrolled and separated, and the section assembly is made up of sections of strips having different widths or the sections of the same strip being situated opposite one another relative to the contact element.

8. The method according to claim 1, wherein sections and/or section assemblies are adhesively bonded to a plurality of regions of the battery housing situated between the contact element and the insulating layer such that a plurality of separate sections and/or section assemblies results.

9. The method according to claim 1, wherein the contact element is situated at a face that is defined by the basic shape of the battery cell, and when the battery cell is provided with the insulating layer, an edge region of the insulating layer is applied to this face, and the section and/or the section assembly are/is adhesively bonded overlapping with this edge region.

10. The method according to claim 1, wherein the battery cells have an at least essentially cuboidal basic shape, and at opposite faces that are defined by the basic shape of the battery cells, in each case have a contact element and a region of the housing situated between the contact element and the insulating layer to which a section and/or a section assembly are/is adhesively bonded.
